(19) United States
(12) Patent Application Publication
(10) Pub. No.: US 2013/0000491 A1
(43) Pub. Date: Jan. 3, 2013

(54) AUTOMATIC BREAD MAKER

(76) Inventors: Yasuyuki Ito, Tottori-shi (JP); Syuji Fukuda, Tottori-shi (JP); Yoshinari Shirai, Tottori-shi (JP); Takashi Watanabe, Tottori-shi (JP)

(21) Appl. No.: 13/575,436

(22) PCT Filed: Jan. 31, 2011
(86) PCT No.: PCT/JP2011/051874

§ 371 Date: Jul. 26, 2012

(30) Foreign Application Priority Data
Aug. 18, 2011 (JP) 2010-027693

(51) Int. Cl. A47J 37/01

(52) U.S. Cl. 99/335

(57) ABSTRACT

An automatic bread maker (1) comprises a bread container into which bread ingredients (50) are put; a body (10) for receiving the bread container (50); an automatic feeding mechanism (19, 80) for enabling a portion of the bread ingredients to be automatically fed into the bread container (50); and a control unit (90) for executing a bread-making procedure for making bread. The bread-making procedure executed by the control unit (90) is provided with a plurality of types of bread-making procedures, including a first bread-making procedure and a second bread-making procedure. The control unit (90) varies the method of control related to the timing with which the bread ingredients are fed using the automatic feeding mechanism in the first bread-making procedure and the second bread-making procedure.

### TECHNICAL FIELD

The present invention relates to an automatic bread maker used mainly in typical households.

### BACKGROUND ART

Automatic bread makers for home use on the market generally have a system to make bread in which a bread container, into which the bread ingredients are put, is used as the baking pan (e.g., refer to Patent Document 1). In such an automatic bread maker, a bread container into which bread ingredients have been put is first introduced into a baking chamber in the body. The bread ingredients in the bread container are subsequently kneaded into a dough using a kneading blade provided in the bread container (kneading step). A fermentation step is then performed to ferment the kneaded dough, and the bread is baked using the bread container as the baking pan (baking step).

Among such automatic bread makers, there are those provided with an additional-ingredients container that can bake bread with raisins, nuts, cheese, and other additional ingredients (e.g., refer to Patent Documents 1 to 3). Such automatic bread makers are configured so that the additional ingredients fed into the additional-ingredients container during the kneading step are automatically fed into the bread container by, e.g., program control.

### LIST OF CITATIONS

### Patent Documents

[Patent Document 1] Japanese Patent Publication No. 3191645
[Patent Document 2] Japanese Laid-open Patent Application No. 2006-255071
[Patent Document 3] Japanese Laid-open Patent Application No. 2008-279034

### SUMMARY OF INVENTION

### Technical Problem

Conventionally, flour (wheat flour, rice flour, and the like) produced by milling cereal such as wheat and rice, or mixed flour produced by mixing various supplementary ingredients into the milled flour, are required when bread is made using an automatic bread maker. In typical households, however, cereals are sometimes stored as grains, rather than flour, as represented by rice grains. Therefore, it would be extremely convenient if it were possible to make bread directly from cereal grains using an automatic bread maker. Accordingly, after diligent study the present applicants have invented a method for making bread using cereal grains as a starting ingredient. The present applicants have already submitted a patent application (Japanese Published Unexamined Application No. 2008-201507).

The bread-making method for which an application has already been submitted will be introduced. In this bread-making method, cereal grains are first mixed with a liquid, and the mixture is ground by a grinding blade (grinding step). Then gluten, yeast and other ingredients, for example, are added to the paste-form ground flour obtained from the grinding step, and these bread ingredients are kneaded into a dough (kneading step). After the dough is fermented (fermentation step), the fermented dough is baked into bread (baking step).

In automatic bread makers that incorporate the above-described bread-making steps, bread ingredients exemplified by gluten and dry yeast must be fed into the bread container after the cereal grains have been ground in the grinding step. Therefore, the configuration of the automatic bread maker is preferably one having a system in which these bread ingredients are automatically fed into the bread container.

Also, considering the convenience for the user, the automatic bread maker is preferably configured so as to be capable of handling cases in which cereal grains such as rice grains are used as the starting ingredients and cases in which cereal flour such as wheat flour and/or rice flour is used as starting ingredients. The configuration is preferably one in which a conventional system for automatically feeding raisins and other additional ingredients and a system for automatically feeding gluten, dry yeast, and other bread ingredients are separately provided. However, there is a drawback when the two systems for automatically feeding bread ingredients described above are separately provided in that the size of the automatic bread maker is increased.

In view of the above, an object of the present invention is to provide an automatic bread maker that is provided with a system for automatically feeding bread ingredients and that is convenient for the user. Another object of the present invention is to provide an automatic bread maker that can handle cases in which cereal grains are used as the starting ingredients and cases in which cereal flour is used as the starting ingredients, and that can minimize to the extent possible an increase in size without compromising the convenience of the user.

### Solution to Problem

In order to achieve the aforementioned object, an automatic bread maker according to the present invention comprises: a bread container into which bread ingredients are put; a body for receiving the bread container; an automatic feeding mechanism for allowing a portion of the bread ingredients to be automatically fed into the bread container; and a control unit for executing a bread-making procedure for making bread, wherein the bread-making procedure executed by the control unit is provided with a plurality of types of bread-making procedures, including a first bread-making procedure and a second bread-making procedure; and the control unit varies the method of control related to the timing with which the bread ingredients are fed using the automatic feeding mechanism between in the first bread-making procedure and in the second bread-making procedure.

The term “bread ingredients” in the present invention is used with a broad meaning and includes additional ingredients (e.g., raisins, nuts, and cheese) that are added in order to make bread with additional ingredients.

In the aspect described above, the first bread-making procedure may be a bread-making procedure used in the case that cereal grains are used as the starting ingredients, and the second bread-making procedure may be a bread-making procedure that is used in the case that cereal flour is used as the starting ingredient. In this case, the first bread-making procedure may include a grinding step for grinding the cereal grains inside the bread container accommodated in the body.

In accordance with the automatic bread maker having such a configuration, it is possible to make bread using, e.g., rice grains and other cereal grains as starting ingredients, and it is also possible to make bread using, e.g., wheat flour, rice flour, and other cereal flour as a starting ingredient. Also, in accordance with such an aspect, it is convenient for the user in that a portion of the bread ingredients can be automatically fed at a midway point during bread making.

In the case that cereal grains are used as the starting ingredient, it is not preferred for dry yeast, gluten, and the like to be placed in the bread container from the beginning; such bread ingredients are preferably automatically fed after the cereal grains have been ground. On the other hand, in the case that wheat flour, rice flour, or other cereal flour is used as the starting ingredient, dry yeast, gluten, and the like may be placed in the bread container from the start; therefore, such bread ingredients do not need to be automatically fed. In the case that cereal flour is used as the starting ingredient, bread ingredients that the user desires to have automatically fed are those for making bread with additional ingredients. In other words, in the case that cereal grains are used as the starting ingredient and in the case that cereal flour is used the starting ingredient, the ingredients that a user may strongly desire to have automatically fed will differ and the preferred feeding timings will also differ. In this light, it is possible to provide an automatic bread maker that is convenient for the user when the control method related to the timing for feeding the bread ingredients is made to be different in both cases using the automatic feeding mechanism as in the present aspect. In accordance with the present aspect, an increase in the size of the automatic bread maker can be minimized without unnecessarily increasing the number of automatic feeding mechanisms because the automatic bread maker is configured so as to improve convenience with focus on the points that the user will particularly perceive to be necessary.

In accordance with the present aspect, it is preferred that both the first bread-making procedure and the second bread-making procedure include a kneading step for kneading the bread ingredients inside the bread container into bread dough; the bread ingredients be fed midway through the kneading step using the automatic feeding mechanism in the case of the first bread-making procedure as well as the second bread-making procedure; and the control unit control the automatic feeding mechanism so that the time required from the start of the kneading step until the bread ingredients are automatically fed is shorter in the first bread-making procedure than in the second bread-making procedure.

The bread ingredients (e.g., dry yeast and the like) that the user desires to have automatically fed in the first bread-making procedure may be fed, e.g., prior to the start of the kneading step. However, it is preferred in terms of uniformly mixing the ingredients that the kneading step be started and feeding be carried out while the bread ingredients in the bread container are stirred as in the manner of the present aspect. It is preferred that automatic feeding be carried out in the initial stage of the kneading step in order to achieve uniform mixing. On the other hand, when the bread ingredients (e.g., additional ingredients for bread having additional ingredients (e.g., raisins)) that that the user desires to have automatically fed in the second bread-making procedure are fed prior to the start of the kneading step or are fed in the initial stage of the kneading step, undesirable situation may occur in which the additional ingredients end up being crushed in the kneading step. Accordingly, a preferred aspect is one in which the timing for feeding the bread ingredients occurs sooner in the first bread-making procedure than in the second bread-making procedure as in the present aspect.

In the automatic bread maker having the aspect described above, the automatic feeding mechanism may comprise a bread-ingredients-storage container and a lock release part, the bread-ingredients-storage container being adapted for storing a portion of the bread ingredients, and being provided with a lock mechanism, and the lock release part being adapted for releasing a locked state of the lock mechanism; and the bread-ingredients-storage container may have a container body having an aperture part; a lid body capable of opening and closing the aperture part, the lid body being swingably provided with respect to the container body; and a seal member for sealing the space between the container body and the lid body in a state in which the aperture part has been closed off by the lid body.

According to the present aspect, the bread-ingredients-storage container provided to the automatic bread maker is configured so that the space between the container body and the lid body is sealed by the seal member in a state in which the aperture part is closed off. Accordingly, it is possible to minimize the entry into the bread-ingredients-storage container of moisture generated in the grinding step for grinding, e.g., cereal grains. In the present aspect, it is preferred that the seal member be mounted on the container body. Therefore, this makes it difficult for a situation to occur in which, e.g., dry yeast, gluten, and other bread ingredients catch on the seal member when these bread ingredients are automatically fed. Therefore, in the automatic bread maker of the present aspect, it is possible to minimize a situation in which flour is left behind in the bread-ingredients-storage container and the amount of bread ingredients in the bread container becomes inaccurate when, e.g., dry yeast, gluten, and other bread ingredients are automatically fed; and it is possible to readily make good-quality bread even in the case that cereal grains are used as the starting ingredient.

In the automatic bread maker having the aspect described above, dry yeast is preferably included in the bread ingredients which are automatically fed by the automatic feeding mechanism in the case that the first bread-making procedure is executed. Also, in the present aspect, at least one among gluten, wheat flour, and a thickener may be additionally included in the bread ingredients which are automatically fed by the automatic feeding mechanism in the case that the first bread-making procedure is executed.

In the automatic bread maker having the configuration described above, the bread ingredients which are automatically fed by the automatic feeding mechanism in the case that the second bread-making procedure is executed may be additional ingredients for making bread with additional ingredients.

In the automatic bread maker having the configuration described above, different bread containers are used for the case in which the first bread-making procedure is executed and the case in which the second bread-making procedure is executed.

### Advantageous Effects of the Invention

In accordance with the present invention, it is possible to provide an automatic bread maker that is provided with a system for automatically feeding bread ingredients and that is convenient for the user. Also, in accordance with the present invention, it is possible to provide an automatic bread maker that can handle the case in which cereal grains are used as the starting ingredients and the case in which cereal flour is used as the starting ingredients, and that can be kept to a size that, to the extent possible, does not compromise the convenience of the user. Therefore, it can be expected that bread-making at home will become more accessible and popular.

### BRIEF DESCRIPTION OF THE DRAWINGS

FIG. 1 is a vertical cross-sectional view of the automatic bread maker of the present embodiment, and is a view showing a configuration in the case that rice grains are used as a starting ingredient;

FIG. 2 is a schematic perspective view for illustrating a configuration of a grinding blade and a kneading blade provided to the automatic bread maker according to the present embodiment;

FIG. 3 is a schematic plan view for illustrating a configuration of a grinding blade and a kneading blade provided to the automatic bread maker according to the present embodiment;

FIG. 4 is a top view of the bread container in the automatic bread maker according to the present embodiment when the kneading blade is in the folded orientation;

FIG. 5 is a top view of the bread container in the automatic bread maker according to the present embodiment when the kneading blade is in the open orientation;

FIG. 6 is a schematic plan view showing the state of the clutch in the automatic bread maker according to the present embodiment when the kneading blade is in the open orientation;

FIG. 7 is a schematic perspective view showing a configuration of the bread-ingredients-storage container provided to the automatic bread maker according to the present embodiment;

FIG. 8 is a schematic cross-sectional view in the A-A position of FIG. 7;

FIG. 9 is a control block diagram of the automatic bread maker according to the present embodiment;

FIG. 10 is a vertical cross-sectional view of the automatic bread maker of the present embodiment, and is a view showing a configuration in the case that cereal flour (wheat flour and/or rice flour) is used as a starting ingredient;

FIG. 11 is a schematic diagram showing a flow of a bread-making procedure carried out by the automatic bread maker of the present embodiment;

FIG. 12A is a view for illustrating the situation in which the lock state of the bread-ingredients-storage container is released by a solenoid, and is a view in which the bread-ingredients-storage container is in a locked state in the automatic bread maker of the present invention; and

FIG. 12B is a view for illustrating the situation in which the lock state of the bread-ingredients-storage container is released by a solenoid, and is a view in which the lock state of the bread-ingredients-storage container has been released in the automatic bread maker of the present invention.

### DESCRIPTION OF EMBODIMENTS

Embodiments of an automatic bread maker according to the present invention will be described in detail below with reference to the accompanying drawings. It is to be understood that any specific time, temperature, or other parameters that appear in this specification are merely examples and are not intended in any way to limit the content of the invention.

### (Overall Configuration of the Automatic Bread Maker)

The automatic bread maker of the present embodiment is capable of baking bread using rice grains (a form of cereal grains) as the starting ingredient, and is also capable of baking bread using cereal flour (milled flour) such as wheat flour and/or rice flour as a starting ingredient. The configurations of the bread container and the blade to be used are slightly different for the case in which rice grains are used as the starting ingredient and the case in which cereal flour such as wheat flour and/or rice flour is used as the starting ingredient. The overall configuration of the automatic bread maker is described below using as an example the configuration of the case in which rice grains are used as a starting ingredient. A description shall follow further hereunder of the overall configuration of the automatic bread maker for the portions having a different configuration in the case in which wheat flour and/or rice flour is used as the starting ingredient.

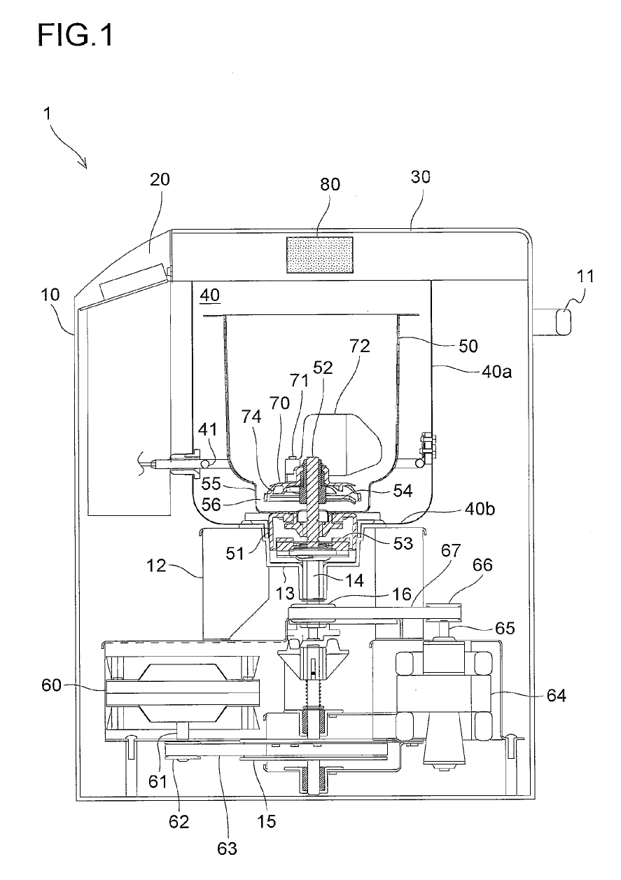

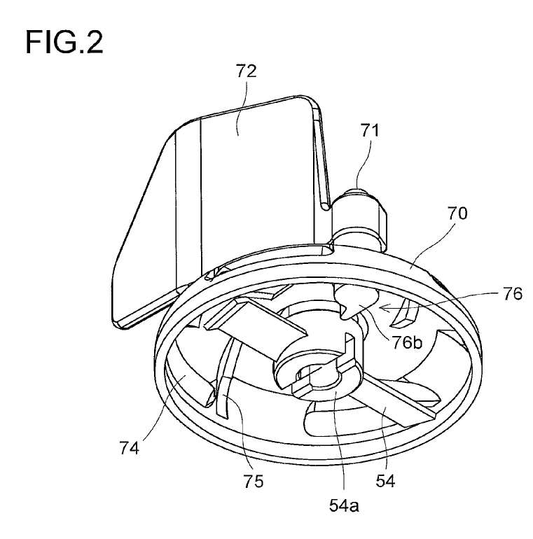

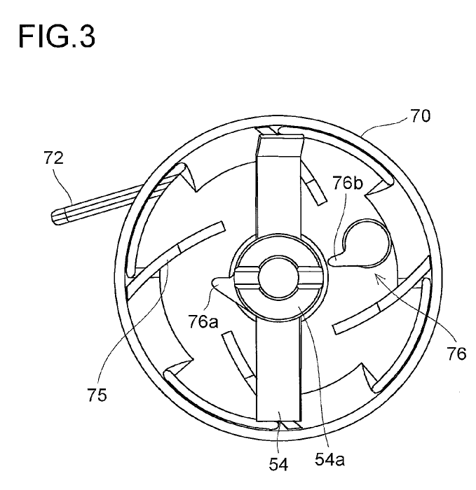

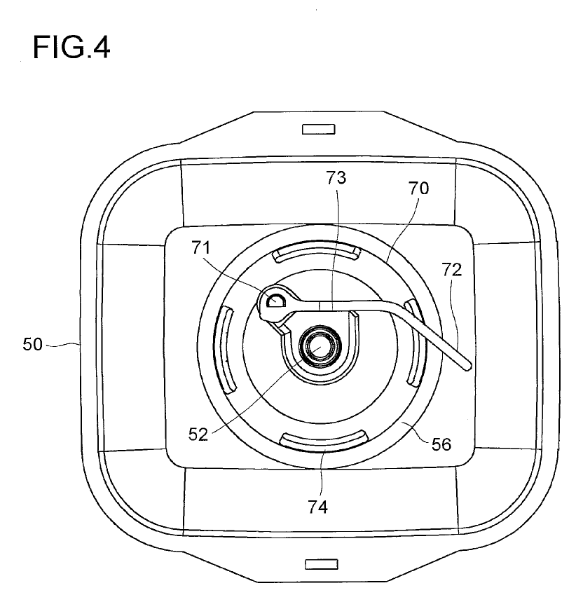

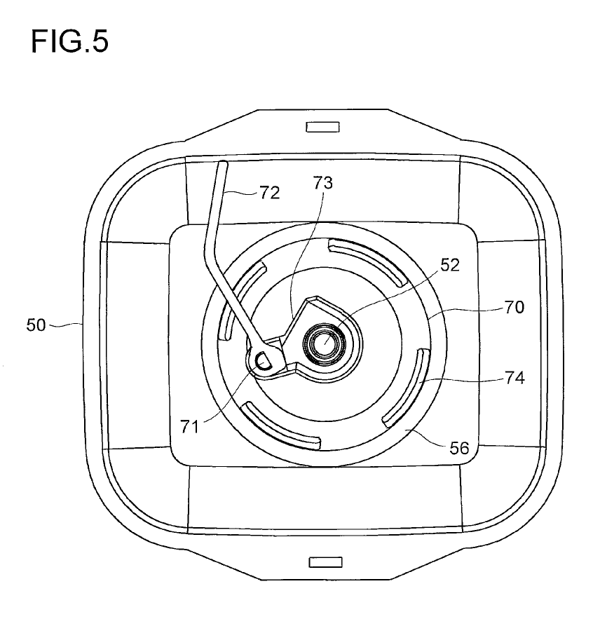

FIG. 1 is a vertical cross-sectional view of the automatic bread maker of the present embodiment, and is a view showing a configuration in the case that rice grains are used as a starting ingredient. FIG. 2 is a schematic perspective view for illustrating a configuration of a grinding blade and a kneading blade provided to the automatic bread maker according to the present embodiment, and is a view observed diagonally from the bottom. FIG. 3 is a schematic plan view for illustrating the configuration of the grinding blade and the kneading blade provided to the automatic bread maker according to the present embodiment, and is a view observed from the bottom. FIG. 4 is a top view of the bread container in the automatic bread maker according to the present embodiment when the kneading blade is in the folded orientation. FIG. 5 is a top view of the bread container in the automatic bread maker according to the present embodiment when the kneading blade is in the open orientation. The configuration of the automatic bread maker 1 of the present embodiment (the configuration used in the case in which rice grains are used as the starting ingredient) will be described below mainly with reference to FIGS. 1 to 5.

In FIG. 1, the left side corresponds to the front (front surface), and the right side corresponds to the back (rear surface), of the automatic bread maker 1. The automatic bread maker 1 has a box-shaped body 10 made of a plastic shell, as shown in FIG. 1. The body 10 is provided with plastic U-shaped handles 11 connected to the two ends of the left and right side surfaces of the body 10, whereby the automatic bread maker 1 can be readily transported.

An operation part 20 is provided on the front part of the top surface of the body 10. Although not shown in the drawings, the operation part 20 is provided with an operating key group including a start key, a cancel key, a timer key, a reservation key, and a selection key for selecting a bread-making procedure (a procedure for making bread using rice grains as a starting ingredient, a procedure for making bread using rice flour as a starting ingredient, a procedure for making bread using wheat flour as a starting ingredient, and other procedures), and a display unit for displaying errors and the like as well as the details set by the operation key group. The display unit is configured, for example, using a liquid crystal display panel and indicator lamps using light emitting diodes as light sources.

The top surface of the body behind the operation part 20 is covered by a plastic lid 30. The lid 30 is mounted to the back surface of the body 10 by a hinge shaft (not shown), and is configured to swing in a vertical plane about the hinge shaft. The lid 30 is provided with an observation window (not shown) made of heat-resistant glass to allow the user to view a baking chamber 40 (described hereafter) through the observation window.

The baking chamber 40, the planar shape of which is substantially rectangular, is provided inside the body 10. The baking chamber 40 is made of a metal plate with the top thereof open, and a bread container 50 is inserted into the baking chamber 40 through the opening. The baking chamber 40 comprises peripheral sidewalls 40a, the horizontal cross-section of which is rectangular, and a bottom wall 40b. A sheath heater 41 is disposed inside the baking chamber 40 so as to surround the bread container 50 placed in the baking chamber 40, thereby making it possible to heat the bread ingredients in the bread container 50. The sheath heater 41 is an example of heating means.

A base 12 made of sheet metal is disposed inside the body 10. A bread container support 13 made of a die-cast molding of an aluminum alloy is fixed at a location corresponding to the center of the baking chamber 40 in the base 12. The interior of the bread container support 13 is exposed within the baking chamber 40.

A motor shaft 14 is vertically supported at the center of the bread container support 13. The motor shaft 14 is caused to rotate via pulleys 15 and 16. A clutch is disposed between the pulley 15 and the motor shaft 14, and between the pulley 16 and the motor shaft 14. A system is therefore provided in which the rotation of the motor shaft 14 is not transmitted to the pulley 16 when the pulley 15 is caused to rotate in one direction and the rotation is transmitted to the motor shaft 14, and in which the rotation of the motor shaft 14 is not transmitted to the pulley 15 when the pulley 16 is caused to rotate in a direction opposite to that of the pulley 15 and the rotation is transmitted to the motor shaft 14.

The unit that causes the pulley 15 to rotate is the kneading motor 60 fixed to the base 12. The kneading motor 60 is a vertical shaft, and an output shaft 61 protrudes from the bottom surface thereof. A pulley 62 connected to the pulley 15 by a belt 63 is fixed to an output shaft 61. The kneading motor 60 is a low-speed/high-torque motor, and the pulley 62 causes the pulley 15 to rotate at a reduced speed. Therefore, the motor shaft 14 rotates at a low speed and high torque.

Similarly, a grinding motor 64 supported on the base 12 causes the pulley 16 to rotate. The grinding motor 64 is also a vertical shaft, and an output shaft 65 protrudes from the top surface thereof. A pulley 66 connected to the pulley 16 by a belt 67 is fixed to an output shaft 65. The grinding motor 64 serves to impart high-speed rotation to a grinding blade described hereafter. Therefore, a high-speed motor is selected for the grinding motor 64, and the speed reduction ratio of the pulley 66 and the pulley 16 is set at approximately 1:1.

The bread container 50 is made from sheet metal and has the shape of a bucket, there being a handle for gripping (not shown) mounted on the rim thereof. The horizontal cross-section of the bread container 50 is a rectangle with four rounded corners. A recess 55 is formed in the bottom part of the bread container 50 to accommodate a grinding blade 54 and a cover 70 (described in detail hereafter). The recess 55 is a circular planar shape and is provided with a gap 56 between the external periphery of the cover 70 and the inside surface of the recess 55 to allow the flow of bread ingredients. Further, a cylindrical pedestal 51 made of a die-cast molding of an aluminum alloy is provided to the bottom surface of the bread container 50. The bread container 50 is disposed in the baking chamber 40 with the bread container support 13 accepting the pedestal 51.

A vertically extending blade rotation shaft 52 is supported at the center of the bottom part of the bread container 50 in a state in which sealing is applied. A rotary force is transmitted to the blade rotation shaft 52 from the motor shaft 14 via a coupling 53. Of the two members constituting the coupling 53, one member is fixed to the bottom end of the blade rotation shaft 52 and the other member is fixed to the top end of the motor shaft 14. The entirety of the coupling 53 is enclosed in the pedestal 51 and the bread container support 13.

Projections (not shown) are formed on the internal circumferential surface of the bread container support 13 and the external circumferential surface of the pedestal 51, and these projections constitute a known bayonet coupling. Specifically, when the bread container 50 is to be mounted on the bread container support 13, the projections on the pedestal 51 are kept from interfering with the projections on the bread container support 13, and the bread container 50 is lowered thereon. After the pedestal 51 is fitted into the bread container support 13, the projections of the pedestal 51 engage with the lower surfaces of the projections of the bread container support 13 when the bread container 50 twists horizontally. The bread container 50 is thereby prevented from slipping out upwards. Further, connection with the coupling 53 is simultaneously achieved by this operation.

The grinding blade 54 is mounted on the blade rotation shaft 52 at a location slightly above the bottom of the bread container 50. The grinding blade 54 is mounted on the blade rotation shaft 52 in a manner so as to be unable to rotate with respect to the blade rotation shaft 52. The grinding blade 54 is made of a stainless steel plate and has a shape such as that of an airplane propeller (this shape is merely an example) as shown in FIGS. 2 and 3. The grinding blade 54 is configured so as to be pulled away and separated from the blade rotation shaft 52, enabling cleaning to be performed after making bread and the grinding blade 54 to be replaced when the edge thereof becomes dull. The grinding blade 54 together with the grinding motor 64 are an example of the grinding mechanism (grinding means).

A dome-shaped cover 70 having a circular planar shape is mounted on the top end of the blade rotation shaft 52. The cover 70 is made of a die-cast molding of an aluminum alloy. The cover 70 is supported by a hub 54a of the grinding blade 54 (see FIGS. 2 and 3) and conceals the grinding blade 54. The cover 70 can also be easily pulled away from the blade rotation shaft 52, enabling cleaning to be readily performed after making bread.

A kneading blade 72, whose planar shape is a sideways V, is mounted on the top exterior surface of the cover 70. The kneading blade 72 is mounted on a vertically extending support shaft 71 arranged in a location separated from the blade rotation shaft 52. The kneading blade 72 is made of a die-cast molding of an aluminum alloy. The support shaft 71 is fixed to or integrated with the kneading blade 72 and moves with the kneading blade 72.

The kneading blade 72 swings, with the support shaft 71 as a center, within the horizontal plane, and has a folded orientation shown in FIG. 4 and an open orientation shown in FIG. 5. In the folding position, the kneading blade 72 contacts a stopper 73 formed on the cover 70, and cannot swing any further in the clockwise direction relative to the cover 70. At this time, the tip of the kneading blade 72 protrudes slightly from the cover 70. In the open orientation, the tip of the kneading blade 72 is separated from the stopper 73 and protrudes significantly from the cover 70.

The kneading blade 72 together with the kneading motor 60 are an example of the kneading mechanism (kneading means). Windows 74 linking the inner space of the cover to the outer space thereof, and ribs 75 provided to the inner surface of the cover 70 and corresponding to the respective windows 74 are formed in the cover 70. The ribs 75 are used for guiding the ingredients ground by the grinding blade 54 toward the windows 74. This configuration improves the efficiency of the grinding in which the grinding blade 54 is used.

As shown in FIG. 3, a clutch 76 is interposed between the cover 70 and the blade rotation shaft 52. The clutch 76 connects the blade rotation shaft 52 and the cover 70 in the rotation direction of the blade rotation shaft 52 when the kneading motor 60 causes the motor shaft 14 to rotate (this rotation direction is the “forward direction rotation”). Conversely, the clutch 76 disconnects the blade rotation shaft 52 from the cover 70 in the rotation direction of the blade rotation shaft 52 when the grinding motor 64 causes the motor shaft 14 to rotate (this rotation direction is the “reverse direction rotation”). In FIGS. 4 and 5, the “forward direction rotation” is the counter-clockwise rotation direction and the “reverse direction rotation” is the clockwise rotation direction.

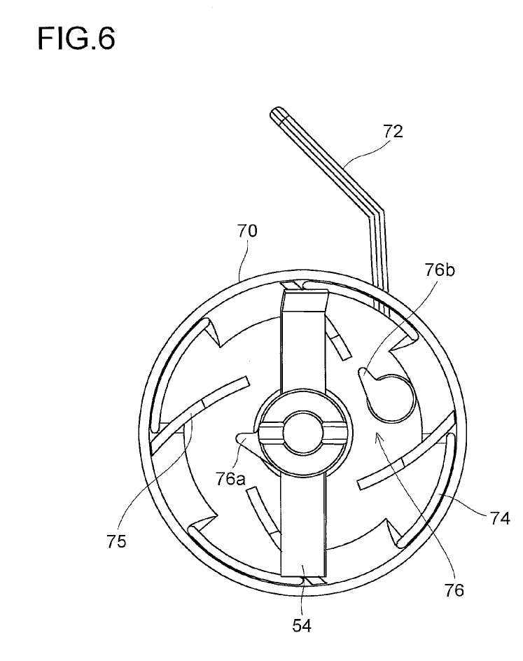

The clutch 76 switches the connection states according to the orientation of the kneading blade 72. In other words, when the kneading blade 72 is in the folded orientation shown in FIG. 4, the second engaging member 76b interferes with the rotation path of the first engaging member 76a, as shown in FIG. 3. Therefore, the first engaging member 76a and the second engaging body 76b engage when the blade rotation shaft 52 rotates in the forward direction, and the rotary force of the blade rotation shaft 52 is transmitted to the cover 70 and the kneading blade 72. In contrast, when the kneading blade 72 is in the open orientation as shown in FIG. 5, the second engaging body 76b departs from the rotation path of the first engaging body 76a, as shown in FIG. 6. Therefore, even when the blade rotation shaft 52 rotates in the reverse direction, the first engaging body 76a and the second engaging member 76b do not engage with each other. The rotary force of the blade rotation shaft 52 accordingly is not transmitted to the cover 70 and the kneading blade 72. FIG. 6 is a schematic plan view showing the state of the clutch when the kneading blade is in the open orientation.

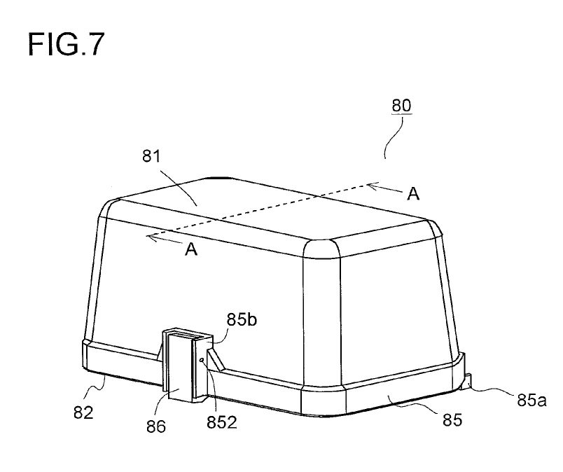

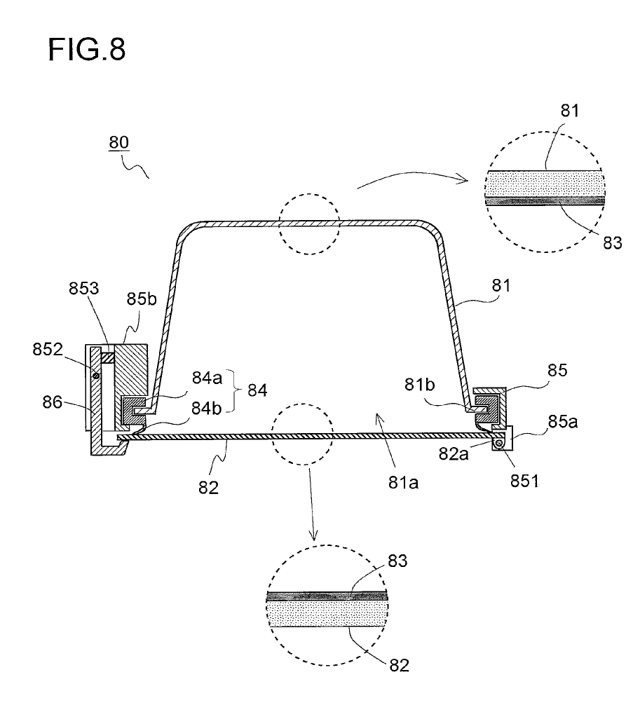

In FIG. 1, the automatic bread maker 1 of the present embodiment is provided with a bread-ingredients-storage container 80 mounted on the lid 30. The present embodiment is configured with the bread-ingredients-storage container 80 mounted on the lid 30, but it is also possible to use a configuration in which the bread-ingredients-storage container is mounted on the body 10 depending on the case. The bread-ingredients-storage container 80 is a container provided so that a portion of the bread ingredients can be automatically fed into the bread container 50 while bread making is in progress. The configuration of the bread-ingredients-storage container 80 is described below with reference to FIGS. 7 and 8. FIG. 7 is a schematic perspective view showing a configuration of the bread-ingredients-storage container provided to the automatic bread maker according to the present embodiment. FIG. 8 is a schematic cross-sectional view in the A-A position of FIG. 7.

The bread-ingredients-storage container 80 mainly comprises a container body 81 and a lid body 82 that can open and close an aperture part 81a present on the container body 81, as shown in FIGS. 7 and 8.

The container body 81 is a box-shaped member having a substantially trapezoidal cross-sectional shape, and more specifically, the portions that connect the side walls and bottom wall (the bottom wall is oriented upward in FIGS. 7 and 8) constituting the container body 81 and the portions that connect the side walls together are rounded. Accordingly, the side and bottom surfaces and side surfaces are smoothly joined without bending sharply in the inner surface side of the container body 81. The planar shape of the aperture part 81a of the container body 81 is substantially rectangular with rounded corners. A guard part (flange part) 81b is formed on the container body 81 so as to project outward from the side edge of the aperture part 81a, as shown in FIG. 8. The guard part 81b is frame shaped with rounded corners when the container body 81 is viewed from above from the aperture part 81a side.

The container body 81 configured in this manner is formed from aluminum, iron, or another metal (including alloys) having a thickness of about, e.g., 1.0 mm. A coating layer 83 based on silicon, fluorine, or the like is provided to the inner surface of the container body 81, as shown in FIG. 8. The metal constituting the container body 81 is not meant to be limited to the given examples, but aluminum is preferably used because the container body 81 will be readily formed as well as for other reasons. The coating layer 83 provided to the inner surface of the container body 81 is not meant to be limited to the given examples, but a silicon-based coating layer is preferred.

The bread-ingredients-storage container 80 described above is used for automatically feeding a portion of the bread ingredients into the bread container 50. Examples of some bread ingredients (described later) include gluten, dry yeast, and other powdered ingredients; and raisins, nuts, and other solid additional ingredients for making bread with additional ingredients. Gluten, dry yeast, and other powdered ingredients stored in the bread-ingredients-storage container 80 readily adhere to the container. It is therefore desirable for the container body 81 of the bread-ingredients-storage container 80 to be configured so that gluten and other powders do not readily adhere.

Therefore, the container body 81 is preferably made of aluminum or another metal rather than a resin, which readily retains electrostatic charge. More preferred than merely using a metal container body 81 is providing a coating layer 83 based on silicon, fluorine, or the like as in the present embodiment in order to improve the slippage characteristics of the powders. The coating layer 83 is baked or otherwise formed on the inner surface of the container body 81. In the case that a fluorine-based substance is used as the coating layer 83, the baking temperature is higher than in the case that a silicon-based substance is used (e.g., about 300° C. in the case that a fluorine-based substance is used, and about 200° C. in the case that a silicon-based substance is used). In the case that the container body 81 is formed using aluminum, the temperature during baking is excessively high when a fluorine-based substance is used as the coating layer 83, and the strength of the container body 81 is reduced. Accordingly, a silicon-based substance is preferably used as the coating layer 83 in the case that the container body 81 is configured using aluminum.

The inner surface of the container body 81 is a smooth surface on which concavities and convexities are not formed and rivets, screws and other protrusions are not disposed in order to make the gluten and other powder be less liable to adhere to the inner surface of the container body 81. As described above, the side and bottom surfaces and the side surfaces of the container body 81 are configured so as to be smoothly joined without sharp bends, the purpose of such design being to make the gluten and other powders less likely to adhere.

Packing 84 made of silicon, for example, is secured to the guard part 81b of the container body 81, as shown in FIG. 8. The packing 84 made of silicon is an embodiment of the seal member of the present invention. The external appearance of the packing 84 is substantially the form of a frame with a planar shape. The packing 84 is configured having a cross-sectional U-shaped mounting part 84a mounted on the container body 81 so as to hold the guard part 81b from above and below, and a thin elastic part 84b folded back so as to protrude from below the mounting part 84a and face the opposite direction from the direction facing the aperture part 81a, as shown in FIG. 8. The packing 84 is secured to the container body 81 by a cover member 85 that is arranged so as to cover the U-shaped mounting part 84a and retains the packing 84 together with the guard part 81b. The material of the cover member 85 is not particularly limited, but an example is polybutylene terephthalate (PBT) in which glass filler has been dispersed.

A lid body support part 85a (refer to FIGS. 7 and 8) for swingably supporting the lid body 82, which is composed of a flat metal plate, is formed at two ends of one of the two long sides of the cover member 85, which is formed substantially the form of a frame with a planar shape. An engagement part 82a (refer to FIGS. 7 and 8) for engaging an engagement protrusion 851 (refer to FIG. 8) that protrudes from the lid body support part 85a is provided at two ends of one of the two long sides of the lid body 82, which has a substantially rectangular planar shape. In other words, the lid body 82 is swingably supported by the cover member 85 about the engagement protrusion 851 (in FIG. 8, the lid body 82 swings in the plane of the page).

A clamp hook support part 85b for rotatably supporting a clamp hook 86 is provided substantially in the center part of the long side on which the lid body support part 85a of the cover member 85 is not formed. The clamp hook support part 85b has a groove shape that extends in a direction (vertical direction of FIG. 8) substantially parallel to the depth direction of the container body 81. A shaft 852 is mounted on the clamp hook support part 85b so that the two ends of the shaft 852 are secured by the two opposing sidewalls, and the clamp hook 86 is swingably supported by the shaft 852. As shown in FIG. 8, a spring 853 for urging the clamp hook 86 outward (leftward in FIG. 8) is mounted on the bottom surface above the shaft 852 of the clamp hook support part 85b provided in shape of a groove.

A portion of the clamp hook 86 having one of the distal-end sides (the lower side in FIG. 8) provided in the form of a hook is thereby caused to make contact with the outer surface (lower surface) of the lid body 82 to support the lid body 82, making it possible for the lid body 82 to maintain the aperture part 81a of the container body 81 in a closed state (the state shown in FIGS. 7 and 8, corresponding to the locked state of the present invention). In a state in which the aperture part 81a of the container body 81 is closed, the lid body 82 completely covers the aperture part 81a with the external circumferential surface part superimposed on the guard part 81b of the container body 81.

The other distal-end side (upper side in FIG. 8) of the clamp hook 86 is pressed from the exterior toward the container body 81 side (right side of FIG. 8), whereby the locked state of the clamp hook 86 is released (support of the lid body 82 by the clamp hook 86 is released) and the lid body 82 can be swung to achieve a state in which the aperture part 81a is opened.

In the present embodiment, the clamp hook 86, the clamp hook support part 85b, the shaft 852, and the spring 853 are an embodiment of the lock mechanism of the present invention. A mounting part (not shown) for securing the bread-ingredients-storage container 80 to the lid 30 of the automatic bread maker 1 is formed on the cover member 85.

The lid body 82 composed of a flat metal plate (having, e.g., a thickness of about 1.0 mm) is preferably formed using aluminum, as is the container body 81, and the coating layer 83 composed of a silicon-base substance or the like is preferably formed on the inner surface (upper surface in FIG. 8) of the lid body 82 as seen in the enlarged view shown in FIG. 8.

In the case that the lid body 82 has closed the aperture 81a of the container body 81 by using the lock mechanism (the state shown in FIGS. 7 and 8), the elastic part 84b of the packing 84 is in constant contact with the inner surface (upper surface in FIG. 8) of the lid body 82. Therefore, in the state in which the lid body 82 has closed the aperture 81b, the space between the lid body 82 and the guard part 81b of the container body 81 is sealed by the packing 84; and moisture, dust, and the like have difficultly entering from the exterior into the container body 81.

The packing 84 secured to the guard part 81b of the container body 81 is provided so as to not protrude into the aperture 81a, as shown in FIG. 8. This design was made with consideration given to the fact that the bread ingredients stored in the bread-ingredients-storage container 80 catch on the packing 84 and remain inside the bread-ingredients-storage container 80 when the packing 84 protrudes into the aperture part 81a, and the amount of fed bread ingredients becomes unsuitable. The packing 84 is secured to the container body 81 side because if the packing 84 is secured to the lid body 82 side, the bread ingredients catch on the packing 84 and the amount of fed bread ingredients becomes unsuitable when the bread ingredients are fed from the bread-ingredients-storage container 80 to the bread container 50.

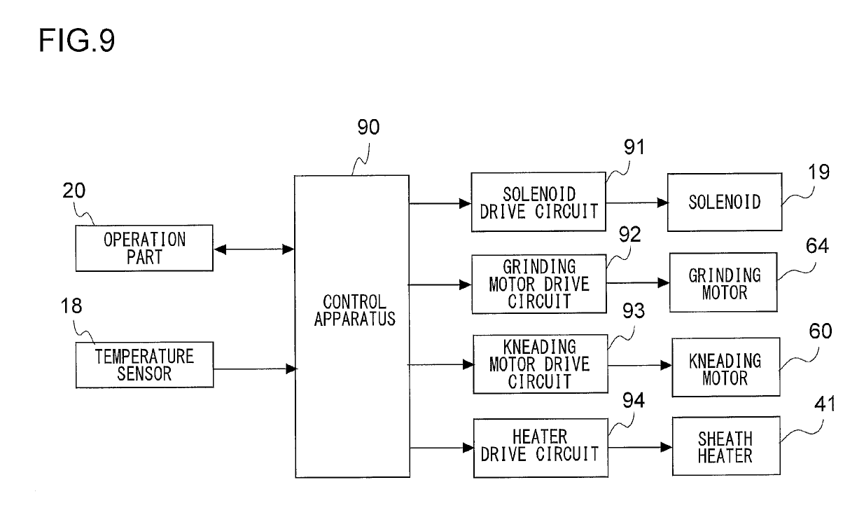

FIG. 9 is a block diagram showing a control of the automatic bread maker according to the present embodiment. A control apparatus 90 controls the operation of the automatic bread maker 1, as shown in FIG. 9. The control apparatus 90 is configured using, for example, a microcomputer composed of a central processing unit (CPU), read only memory (ROM), random access memory (RAM), input/output (I/O) circuitry, and other components. The control apparatus 90 is preferably arranged in a position unlikely to be affected by the heat of the baking chamber 40. Further, the control apparatus 90 comprises a time measurement function, making it possible to perform time control in the bread-making step. The control apparatus 90 is an embodiment of the control unit according to the present invention.

The operation part 20 described above, a temperature sensor 18, a solenoid drive circuit 91, a grinding motor drive circuit 92, a kneading motor drive circuit 93, and a heater drive circuit 94 are electrically connected to the control apparatus 90. The temperature sensor 18 is a sensor provided so that the temperature of the baking chamber 40 can be detected.

The solenoid drive circuit 91 is a circuit for controlling the driving of a solenoid 19 under instruction from the control apparatus 90. The solenoid 19 is provided for releasing the lock mechanism provided to the bread-ingredients-storage container 80 described above, and is mounted on the lid 30 of the automatic bread maker 1. However, the solenoid 19 may be mounted on the body 10 in some cases. When the solenoid 19 is driven, the amount the plunger protrudes from the housing is increased. The clamp hook 86 constituting the lock mechanism is pressed by the plunger or the movable member that is pressed by the plunger to allow movement, and the locked state of the lock mechanism is released. The solenoid 19 is an embodiment of the lock release mechanism of the present invention. The bread-ingredients-storage container 80 provided with a lock mechanism, and the lock release part having the solenoid 19 are an embodiment of the automatic feeding mechanism (automatic feeding means) of the present invention.

The grinding motor drive circuit 92 is a circuit for controlling driving of the grinding motor 64 under instruction from the control apparatus 90. The kneading motor drive circuit 93 is a circuit for controlling driving of the kneading motor 60 under instruction from the control apparatus 90. The heater drive circuit 94 is a circuit for controlling the operation of the sheath heater 41 under instruction from the control apparatus 90.

The control apparatus 90 reads a program related to the bread-making procedure stored in the ROM or the like on the basis of an input signal from the operation part 20, and causes the automatic bread maker 1 to carry out bread-making steps while controlling the driving of the solenoid 19 via the solenoid drive circuit 91, the rotation of the grinding blade 54 via the grinding motor drive circuit 92, the rotation of the kneading blade 72 via the kneading motor drive circuit 93, and the heating operation of the sheath heater 41 via the heater drive circuit 94.

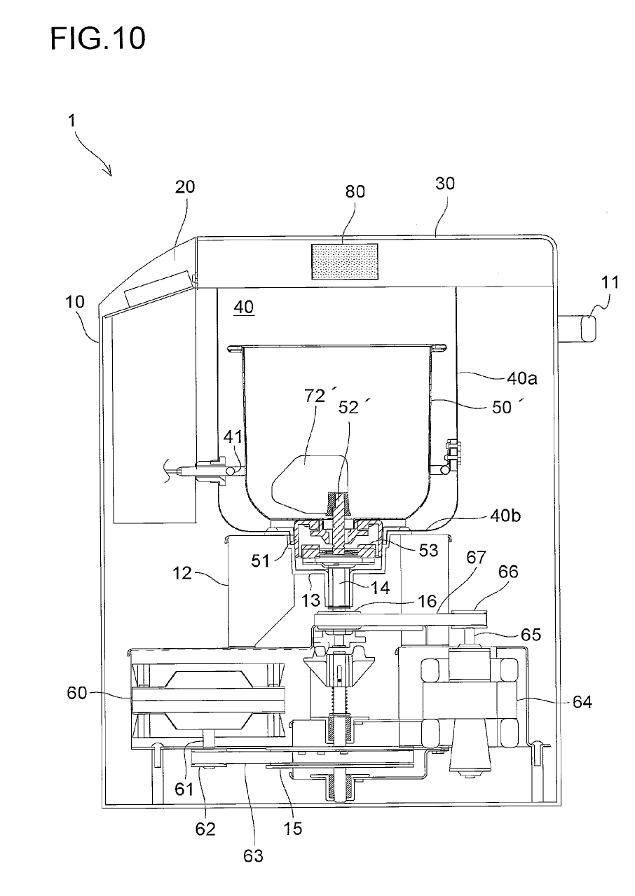

The preceding is a description of the overall configuration of the automatic bread maker 1 of the present embodiment, and a configuration for the case of baking bread using rice grains as a starting ingredient. In the case of baking bread using cereal flour such as wheat flour and/or rice flour as the starting ingredient, the configuration is slightly different. These points of difference will be described with reference to FIG. 10. FIG. 10 is a vertical cross-sectional view of the automatic bread maker of the present embodiment, and is a view showing the configuration in the case that cereal flour (wheat flour and/or rice flour) is used as a starting ingredient.

In the case that cereal flour such as wheat flour and/or rice flour is used as the starting ingredient, a step for grinding the rice grains is not required, as shown in FIG. 10. Therefore, the configuration shown in FIG. 10 is not provided with a grinding blade 54 and a cover 70. In order to address this difference, a bread container 50′ which is different from the case in which rice grains are used as the starting ingredient is used when cereal flour such as wheat flour and/or rice flour is used a starting ingredient. Specifically, the bread container 50′ has a flat bottom part and a recess 55 (refer to FIG. 1) such as that described above is not provided.

Since the configuration is not provided with a cover 70, a kneading blade 72′ which is different from the case in which rice grains are used as the starting ingredient is used. The kneading blade 72′ is mounted merely by being fitted onto a blade rotation shaft 52′ that is supported in the center of the bottom part of the bread container 50′ (the blade rotation shaft 52′ having a slightly different configuration from the blade rotation shaft 52 because the grinding blade 54 and the cover 70 are not provided), and can be detachably mounted without the use of a tool. The bread container 50′ is secured to the bread container support 13 by a bayonet coupling, and this coupling makes it possible for drive force to be transmitted from the motor shaft 14 to the blade rotation shaft 52′ via the coupling 53.

[Operation of the Automatic Bread Maker]

Described next is the operation of the automatic bread maker 1 configured in the manner described above. As described above, the automatic bread maker 1 of the present embodiment is capable of baking bread using rice grains as the starting ingredient, and is also capable of baking bread using cereal flour such as wheat flour and/or rice flour as a starting ingredient. The user can operate the operation part 20 to select a bread-making procedure from among a plurality of types of bread-making procedures and to automatically bake bread in accordance with the desired type of bread. In order to facilitate understanding of the features of the automatic bread maker 1 of the present embodiment, the operation of the automatic bread maker 1 will be described below using as examples the case in which a rice-grain bread-making procedure is executed for baking bread using rice grains as the starting ingredient, and the case in which a gourmet wheat bread procedure is executed for baking bread with additional ingredients using wheat flour as the starting ingredient. The rice-grain bread-making procedure is an embodiment of the first bread-making procedure of the present invention, and the gourmet wheat bread procedure is an embodiment of the second bread-making procedure of the present invention.

### 1. Rice-Grain Bread-Making Procedure

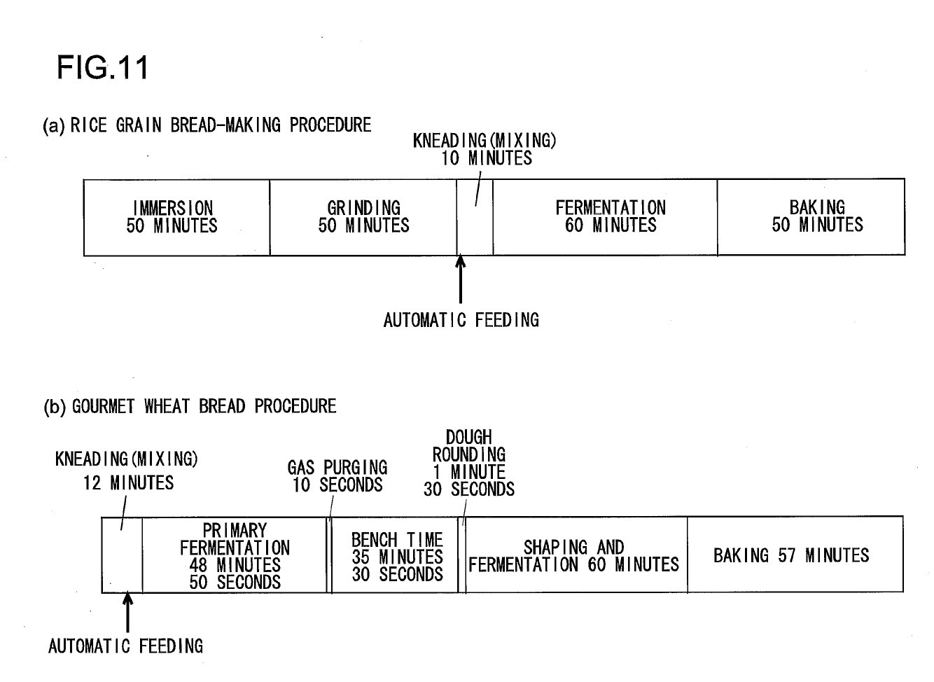

FIG. 11 is an illustrative diagram showing the flow of a rice-grain bread-making procedure carried out by the automatic bread maker 1. In the rice-grain bread-making procedure, an immersion step, a grinding step, a kneading (mixing) step, a fermentation step, and a baking step are sequentially performed in the stated order, as shown in FIG. 11.

A user mounts the grinding blade 54 and the cover 70, on which the kneading blade 72 is attached, in the bread container 50 in order to perform the rice-grain bread-making procedure. The user then measures the respective predetermined amounts of rice grains and water and puts them in the bread container 50. Here, rice grains and water are mixed, but a liquid having a taste component such as a soup stock, fruit juice, a liquid containing alcohol, or another liquid, for example, may be used in place of plain water.

The user measures a predetermined amount of each of the bread ingredients (ordinarily, a plurality) other than rice grains and water, and places the bread ingredients into the container body 81 of the bread-ingredients-storage container 80. The user stores the bread ingredients that need to be stored in the container body 81, then arranges the lid body 82 so as to close off the aperture part 81a of the container body 81, and supports the lid body 82 with the clamp hook 86 to achieve a locked state.

Examples of the bread ingredients stored in the bread-ingredients-storage container 80 include gluten, dry yeast, salt, sugar, and shortening. Instead of gluten, or together with gluten, it is possible to store, e.g., wheat flour, joshinko (top-grade rice flour made from non-glutinous rice), or thickener (guar gum or the like) in the bread-ingredients-storage container 80. It is also possible to store, e.g., dry yeast, salt, sugar, and shortening in the bread-ingredients-storage container 80 without the use of gluten, wheat flour, joshinko, and a thickener. In some cases, it is possible to add, e.g., salt, sugar, and shortening together with the rice grains to the bread container 50, and to store only, e.g., gluten and dry yeast in the bread-ingredients-storage container 80.

The user thereafter places the bread container 50, into which the rice grains and water have been put, into the baking chamber 40, mounts the bread-ingredients-storage container 80 in a predetermined position, closes the lid 30, selects a rice-grain bread-making procedure using the operation part 20, and presses the start key. This starts the rice-grain bread-making procedure for making bread using rice grains as a starting ingredient.

The bread-ingredients-storage container 80 is arranged so that at least a portion of the aperture part 81a faces the aperture of the bread container 50 in a state in which the aperture part 81a has been opened. In the case of a configuration in which only a portion of the aperture 81a faces the aperture of the bread container 50, an arrangement is required to ensure that the bread ingredients are fed into the bread container 50 without leaking to the exterior. An example of such an arrangement is to configure the bread-ingredients-storage container 80 so that the lid body 82 makes contact with the edge of the bread container 50 when the lid body has been unlocked, swung, and set in a diagonal state, and so that the bread ingredients are fed into the bread container 50 while sliding over the lid body 82.

When the rice-grain bread-making procedure is started, the immersion step is started by instruction from the control apparatus 90. In the immersion step, the mixture of rice grains and water is left in a stationary state, and the stationary state is maintained for a predetermined time (50 minutes in the present embodiment) set in advance. In the immersion step, water soaks into the rice grains, which is performed to facilitate the grinding of the rice grains to the cores in the grinding step performed subsequently.

The water-absorption speed of the rice grains varies with the water temperature. That is, the water-absorption speed increases with a high water temperature and decreases with a low water temperature. Accordingly, the time of the immersion step may be varied in accordance with, e.g., the ambient temperature in which the automatic bread maker 1 is used and other parameters. Variability in the water absorption of the rice grains can thereby be minimized. It is possible to energize the sheath heater 41 during the immersion step to increase the temperature of the baking chamber 40 in order to shorten the immersion time.

In the immersion step, the grinding blade 54 may be caused to rotate in the initial stage and caused to rotate intermittently thereafter. Such a configuration makes it possible to scar the surfaces of the rice grains, improving the liquid-absorption efficiency of the rice grains.

When the above-noted predetermined time has elapsed, the immersion step is ended and the grinding step for grinding the rice grains is started by instruction from the control apparatus 90. In the grinding step, the grinding blade 54 is rotated at high speed in the mixture of rice grains and water. Specifically, the control apparatus 90 controls the grinding motor 64, rotating the blade rotation shaft 52 in the reverse direction and starting the grinding blade 54 rotating in the mixture of rice grains and water. In this event, the cover 70 also starts to rotate in association with the rotation of the blade rotation shaft 52, but the following operation immediately stops the rotation of the cover 70.

The rotation direction of the cover 70 accompanying the rotation of the blade rotation shaft 52 for rotating the grinding blade 54 is clockwise in FIG. 4, and, in a case that the kneading blade 72 has been in the folded orientation (the orientation shown in FIG. 4), the kneading blade 72 is changed to the open orientation (the orientation shown in FIG. 5) by resistance from the mixture of the rice grains and water. When the kneading blade 72 moves to the open orientation, the second engaging body 76b departs from the rotation path of the first engaging body 76a, and therefore the clutch 76 disconnects the blade rotation shaft 52 from the cover 70 as shown in FIG. 6. At the same time, the kneading blade 72 in the open orientation hits the inner wall of the bread container 50 as shown in FIG. 5, stopping the rotation of the cover 70.

In the grinding step, the rice grains are ground in a state in which water has permeated the rice grains by the preceding immersion step, and therefore the rice grains can be readily ground to their cores. Rotation of the grinding blade 54 in the grinding step is intermittent in the present embodiment. This intermittent rotation is performed, e.g., in a cycle in which rotation occurs for 30 seconds and is stopped for five minutes, and the cycle is repeated 10 times. In the final cycle, the five-minute stoppages are not performed. The rotation of the grinding blade 54 may be continuous, but intermittent rotation is preferred in order, e.g., to prevent the temperature of the ingredients in the bread container 50 from becoming excessively high, and for other purposes.

The grinding step is ended in a predetermined length of time (50 minutes in the present embodiment) in the automatic bread maker 1. However, the hardness of the rice grains may vary, and the granularity of the ground flour may vary depending on ambient conditions. Therefore, it is possible to use a configuration in which the magnitude of the load (which can be determined by, e.g., the control current or the like of the motor) on the grinding motor 64 during grinding is used as an indicator for determining the end of the grinding step.

In the grinding step, heat is generated by friction between the rice grains and the grinding blade 54 when the rice grains are ground, and the moisture inside the bread container 50 is more readily evaporated away. In this case, there is concern that moisture will penetrate the bread-ingredients-storage container 80 arranged above the bread container 50, and that the bread ingredients will adhere to the bread-ingredients-storage container 80 and will not readily drop from the bread-ingredients-storage container 80 when the later-described bread ingredients are automatically fed. However, the bread-ingredients-storage container 80 is capable of minimizing such adhering of the bread ingredients to the container because moisture penetration is less likely due to the packing 84.

When the grinding step is ended, the kneading step is started by instruction from the control apparatus 90. The kneading step must be performed at a temperature (e.g., about 30° C.) at which the yeast can actively work. Therefore, the kneading step may be started when a predetermined temperature range has been reached.

When the kneading step begins, the control apparatus 90 controls the kneading motor 60 so as to cause the blade rotation shaft 52 to rotate in the forward direction. The cover 70 rotates in the forward direction (i.e., CCW in the view of FIG. 5) in association with the rotation in the forward direction of the blade rotation shaft 52, causing the kneading blade 72 to change from the open orientation (refer to FIG. 5) to the folded orientation (refer to FIG. 4) due to the drag of the bread ingredients (which a mixture of water and ground flour from rice grains at this stage) contained in the bread container 50. As a result, the clutch 76 forms an angle that causes the second engaging body 76b to interfere with the rotation path of the first engaging body 76a, thus connecting the blade rotation shaft 52 to the cover 70 as shown in FIG. 3. This causes the cover 70 and kneading blade 72 to integrally rotate in the forward direction with the blade rotation shaft 52. The kneading blade 72 rotates at a slow speed and high torque.

The rotation of the kneading blade 72 is initially extremely slow in the kneading step, and the speed is increased in a stepwise fashion under the control of the control apparatus 90. In the initial stage of the kneading step in which the rotation of the kneading blade 72 is extremely slow (e.g., until 30 seconds have elapsed after the start), the control apparatus 90 drives the solenoid 19 and releases the lock state of the lock mechanism provided to the bread-ingredients-storage container 80. Gluten, dry yeast, salt, sugar, shortening and other such bread ingredients are thereby automatically fed into the bread container 50.

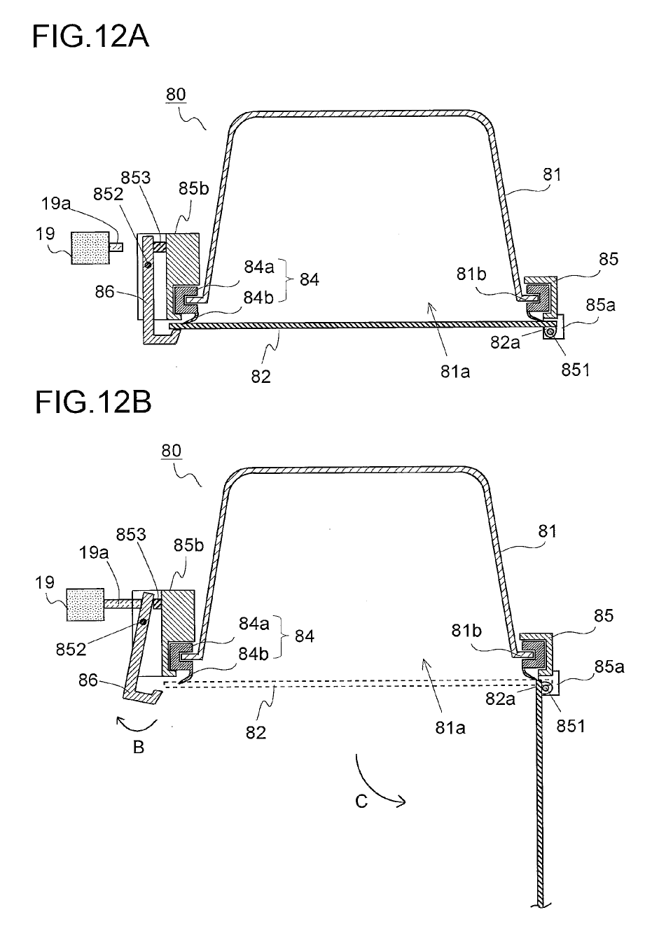

FIGS. 12A and 12B are views for illustrating the circumstance in which the locked state of the bread-ingredients-storage container is released by a solenoid, wherein FIG. 12A is a view of the case in which the bread-ingredients-storage container is in a locked state, and FIG. 12B is a view of the case in which the locked state of the bread-ingredients-storage container has been released. When the solenoid 19 is driven by instruction from the control apparatus 90, the upper part of the clamp hook 86 is pressed by a plunger 19a of the solenoid 19 and the clamp hook 86 swings in the arrow B direction about the shaft 852, as shown in FIGS. 12A and 12B. The engagement of the clamp hook 86 and the lid body 82 is thereby released and the lid body 82 swings in the arrow C direction. When the lid body 82 swings, the aperture part 81a of the container body 81 is opened and the bread ingredients therefore drop into the bread container 50 below the bread-ingredients-storage container 80.

A preferred configuration is one in which the position of the lid body 82 after the aperture part 81a has opened is a position that is not in contact with the bread dough in the fermentation step that is performed thereafter.

As described above, the bread-ingredients-storage container 80 is designed so that a coating layer 83 is provided to the interior of the container body 81 and the lid body 82 to improve slipping characteristics, and concavities and convexities are not provided to the interior. Further, a situation in which the bread ingredients catch on the packing 84 is minimized by the method in which the packing 84 is arranged. Therefore, the bread ingredients substantially do not remain in the bread-ingredients-storage container 80.

Even with the above-described designs, it is still possible for the bread ingredients to remain adhering inside the bread-ingredients-storage container 80. Therefore, the solenoid 19 may be intermittently driven to knock the clamp hook 86 (to cause an impact with the clamp hook 86) and impart vibrations to the bread-ingredients-storage container 80 to cause the bread ingredients remaining in the container to drop. The timing for driving the solenoid 19 is preferably one when the upper part of the clamp hook 86 has approached the solenoid 19 side due to the urging force of the spring 853.

In the present embodiment, the bread ingredients stored in the bread-ingredients-storage container 80 are fed into the bread container 50 in a state in which the kneading blade 72 is rotating. However, no limitation is imposed thereby, it being also possible for the bread ingredients stored in the bread-ingredients-storage container 80 to be fed into the bread container 50 in a state in which the kneading blade 72 is stopped (e.g., between the end of the grinding step and the start of the kneading step). However, in terms of uniformly dispersing the bread ingredients, it is preferred that the bread ingredients be fed in a state in which the kneading blade 72 is rotating in the manner of the present embodiment.

After the bread ingredients stored in the bread-ingredients-storage container 80 have been fed into the bread container 50, the bread ingredients are kneaded inside the bread container 50 by the rotation of the kneading blade 72 to become an integrated ball of dough having a predetermined elasticity. The kneading blade 72 tosses the dough about and beats it against the inner wall of the bread container 50, adding the element of “kneading” to the mixing. The cover 70 also rotates with the rotation of the kneading blade 72. When the cover 70 rotates, the bread ingredients inside the cover 70 are rapidly discharged from the windows 74 and are assimilated into the mass of bread ingredients (dough) being kneaded by the kneading blade 72 because the ribs 75 formed in the cover 70 also rotate.

In the automatic bread maker 1, the time for the kneading step may be a predetermined time (10 minutes in the present embodiment) obtained by experimentation as the time required to obtain a bread dough having desired elasticity. However, when the time for the kneading step is fixed, the quality of the bread dough may vary due to ambient temperature or another factor. Therefore, it is possible use a configuration in which the magnitude of, e.g., the load (which can be determined by, e.g., the control current or the like of the motor) on the kneading motor 60 is used as an indicator for determining the end of the kneading step.

When bread containing additional ingredients (e.g., raisins, nuts, cheese) is baked, the additional ingredients are fed by hand by the user during the kneading step.

When the kneading step is ended, a fermentation step is started according to an instruction from the control apparatus 90. In the fermentation step, the control apparatus 90 controls the sheath heater 41 and keeps the temperature of the baking chamber 40 to a temperature (e.g., 38° C.) that facilitates fermentation. The dough is left standing for a predetermined time (60 minutes in the present embodiment) in an environment that promotes fermentation.

Depending on the situation, a process such as rotating the kneading blade 72 to deflate or round the dough may be performed during the fermentation step.

When the fermentation step is ended, a baking step is started by an instruction from the control apparatus 90. The control apparatus 90 controls the sheath heater 41 and increases the temperature of the baking chamber 40 to a temperature (e.g., 125° C.) suitable for baking bread. The bread is baked for a predetermined time (50 minutes in the present embodiment) in a baking environment. The user is notified of the end of the baking step, e.g., by a display on a liquid crystal display panel, an audio alert, or the like (neither is shown) on the operation part 20. When the bread-making is detected to be complete, the user opens the lid 30 and removes the bread container 50 to complete the bread making.

The automatic bread maker of the present embodiment is configured so that the bread-ingredients-storage container 80 is arranged on the lid 30 and the container body 81 and the lid body 82 are formed from metal. Therefore, in the baking step, heat is readily reflected by the bread-ingredients-storage container 80 and baking non-uniformities on the top surface or the like of the bread can be prevented.

### 2. Gourmet Wheat Bread Procedure

FIG. 11 is an illustrative diagram showing a flow of a gourmet wheat bread-making procedure carried out by the automatic bread maker 1. In the gourmet wheat bread procedure, a kneading (mixing) step, a primary fermentation step, a gas-purging step, a dough rest step (also referred to as bench time and resting), a dough rounding step, a shaping and fermentation step, and a baking step are sequentially executed in the stated order, as shown in FIG. 11.

When the gourmet wheat bread procedure is executed, the user prepares the bread container 50′ (refer to FIG. 10), which is different from that of the rice-grain bread-making procedure, and mounts the kneading blade 72′ (refer to FIG. 10) onto the bread container 50′. The user places a predetermined amount of water in the bread container 50′, thereafter adds predetermined amounts of wheat flour, salt, sugar, and shortening, and lastly adds dry yeast to the bread container 50′ so that contact with the water is avoided. The amount of seasonings such as salt, sugar, and shortening may be suitably modified in accordance with the preference of the user.

The user puts a predetermined amount of additional ingredients (e.g., raisins, nuts, and cheese), which are fed as bread ingredients for making bread with additional ingredients, in the container body 81 of the bread-ingredients-storage container 80. When the required bread ingredients have been stored in the container body 81, the user arranges the lid body 82 so as to close off the aperture 81a of the container body 81, and supports the lid body 82 with the clamp hook 86 to achieve a lock state.

The user thereafter inserts into the baking chamber 40 the bread container 50′, into which the bread ingredients have been put earlier, mounts the bread-ingredients-storage container 80 in a predetermined position, closes the lid 30, selects the gourmet wheat bread procedure by operating the operation part 20, and presses the start key. This starts the gourmet wheat bread procedure for making bread with additional ingredients using wheat flour as a starting ingredient.

When the gourmet wheat bread procedure is started, the kneading step is started by an instruction from the control apparatus 90. When the kneading step is started, the control apparatus 90 controls the kneading motor 60 so as to cause the blade rotation shaft 52′ (refer to FIG. 10) to rotate in the forward direction. The kneading blade 72′ is thereby rotated at low speed and high torque. The rotation of the kneading blade 72 is initially extremely slow in the kneading step, and the speed is increased in a stepwise fashion under the control of the control apparatus 90.

The bread ingredients in the bread container 50′ are mixed and kneaded by the rotation of the kneading blade 72′ to become an integrated ball of dough having a prescribed elasticity. The kneading blade 72′ tosses the dough about and beats it against the inner wall of the bread container 50′, adding the element of “kneading” to the mixing. The kneading step is carried out for a predetermined time (12 minutes in the present embodiment) obtained by experimentation as the time required to obtain a bread dough having desired elasticity.

The control apparatus 90 drives the solenoid 19 to release the lock mechanism provided to the bread-ingredients-storage container 80 and automatically feeds the addition ingredients (raisins and the like), which are stored in the bread-ingredients-storage container 80, into the bread container 50′ at predetermined time prior to the end of the kneading step (five minutes in the present embodiment, (which is seven minutes after the start of the kneading step)). The operation of the solenoid 19 and the bread-ingredients-storage container 80 during automatic feeding is the same as the operation during automatic feeding in the rice-grain bread-making procedure as described above (refer to FIGS. 12A and 12B).

In the gourmet wheat bread procedure, the automatic feeding operation is executed after the kneading step is progressed for a certain length of time, and this is different from the case of the rice-grain bread-making procedure. This is done in order to avoid the possibility that the additional ingredients will be crushed in a configuration in which the additional ingredients are fed by the automatic feeding operation prior to the start of the kneading step or in the initial stage of the kneading step. When the timing for feeding the additional ingredients is excessively late, the additional ingredients remain together without being dispersed in the bread dough, and the timing for feeding the additional ingredients is therefore not set to be near the end of the kneading step.

When the kneading step is ended, a primary fermentation step for allowing the bread dough to ferment is started according to an instruction from the control apparatus 90. When the primary fermentation step is started, the control apparatus 90 controls the sheath heater 41 and keeps the temperature of the baking chamber 40 at a predetermined temperature (32° C. in the present embodiment) that promotes fermentation. The primary fermentation step is carried out for 48 minutes 50 seconds in the present embodiment.

When the primary fermentation step is ended, a gas-purging step for purging gas contained in the bread dough is started according to an instruction from the control apparatus 90. In the gas-purging step, the control apparatus 90 controls the driving of the kneading motor 60 and causes the kneading blade 72′ to rotate continuously for a predetermined length of time (10 seconds in the present embodiment). In the gas-purging step, the control apparatus 90 also controls the sheath heater 41 in order keep the temperature of the baking chamber 40 at a predetermined temperature.

When the gas-purging step is ended, the dough rest step for resting the bread dough (also referred to as bench time and “resting”) is executed according to a command from the control apparatus 90. In this bench time, the control apparatus 90 controls the sheath heater 41 and keeps the temperature of the baking chamber 40 at a predetermined temperature (32° C. in the present embodiment). Bench time is carried out for 35 minutes 30 seconds in the present embodiment.

When the dough rest step is ended, a dough rounding step for rounding the bread dough is started according to an instruction from the control apparatus 90. In the dough rounding step, the control apparatus 90 controls the driving of the kneading motor 60 and causes the kneading blade 72′ to rotate. In the dough rounding step, the kneading blade 72′ is caused to rotate very slowly for a predetermined length of time (1 minute 30 seconds in the present embodiment).

When the dough rounding step is ended, a shaping and fermentation step for allowing the bread dough to ferment again is started according to an instruction from the control apparatus 90. In the shaping and fermentation step, the control apparatus 90 controls the sheath heater 41, keeps the temperature of the baking chamber 40 at a predetermined temperature (38° C. in the present embodiment) that promotes fermentation, and maintains this state for a predetermined length of time (60 minutes in the present embodiment).

When the shaping and fermentation step is ended, a baking step for baking the bread dough is carried out according to an instruction from the control apparatus 90. In the baking step, the control apparatus 90 controls the sheath heater 41 and increases the temperature of the baking chamber 40 to a temperature (115° C. in the present embodiment) suitable for baking bread. The bread is baked for a predetermined time (57 minutes in the present embodiment) in a baking environment. The user is notified of the end of the baking step, e.g., by a display on a liquid crystal display panel, an audio alert, or the like (neither is shown) on the operation part 20. When the bread-making is detected to be complete, the user opens the lid 30, removes the bread container 50′, and completes the bread making.

(Summary of the Automatic Bread Maker of the Present Embodiment)

As described above, in accordance with the automatic bread maker 1 of the present embodiment, bread can be baked using rice grains as the starting ingredient, and bread can be baked using cereal flour such as wheat flour and/or rice flour as a starting ingredient. Therefore, the automatic bread maker of the present embodiment is extremely convenient for the user and expands the range of bread making for the user.

The automatic bread maker 1 of the present embodiment is capable of automatically feeding a portion of the bread ingredients at a midway point of bread making. The bread ingredients that a user desires to have automatically fed at a midway point during bread making ordinarily differ in the case that bread is made using rice grains as a starting ingredient and in the case that bread is made using cereal flour such as wheat flour and/or rice flour as the starting ingredient. In consideration of these points, the control apparatus 90 of the automatic bread maker 1 of the present embodiment is configured so as to carry out different control for the timing for feeding the bread ingredients in the two cases. Therefore, the automatic bread maker 1 of the present embodiment is configured so as to improve the convenience of the user without unnecessarily increasing the number of automatic feeding mechanisms and increasing the size of the bread maker.

### Other Embodiments

The automatic bread maker illustrated above is one example of the present invention, but the configuration of an automatic bread maker utilizing the present invention is not limited by the embodiments illustrated above.

In the embodiment described above, the configuration of the automatic feeding mechanism composed of the bread-ingredients-storage container 80 and the solenoid 19 is merely one example. In other words, as shall be apparent, the configuration of the automatic feeding mechanism may be another configuration as long as it is one in which a portion of the bread ingredients can be automatically fed.

The rice grains in the embodiment described above are an example of cereal grains, but instead of rice grains, it also possible to use the present invention in the case that the grains are wheat, barley, millet, Japanese millet, buckwheat, corn, soy bean, and other grains. Wheat flour and rice flour are also examples of cereal flour, and in place of the wheat flour and rice flour, it is also possible to the use the present invention in the case that the flour is obtained by milling wheat, barley, millet, Japanese millet, buckwheat, corn, soy bean, and other grains.

The bread-making steps carried out in the above-described rice-grain bread-making procedure and the wheat gourmet bread procedure are examples, and other steps may be employed. Another example of the rice-grain bread-making procedure is to carry out the immersion step again and thereafter carry out the kneading step in order to cause the ground flour to absorb the water after the grinding step.

In the embodiment described above, the configuration of the bread container and the kneading blade was different in the rice-grain bread-making procedure and the gourmet wheat bread procedure, but it is also possible to leave the configuration of the bread container and the kneading blade unchanged in the rice-grain bread-making procedure and the gourmet wheat bread procedure.

### INDUSTRIAL APPLICABILITY

The present invention is suitably used in an automatic bread maker for household use.

### LIST OF REFERENCE SIGNS

1 automatic bread maker
10 body
19 solenoid (lock release part, a part of the automatic feeding mechanism)
50, 50′ bread container
80 bread ingredients storage container
81 container body
81a aperture
82 lid body
84 packing (seal member)
85b clamp hook support part (a part of the lock mechanism)
85b clamp hook (a part of the lock mechanism)
852 shaft (a part of the lock mechanism)
853 spring (a part of the lock mechanism)
90 control apparatus (control unit)

1. An automatic bread maker comprising:
a bread container into which bread ingredients are put;
a body for receiving the bread container;
an automatic feeding mechanism for allowing a portion of the bread ingredients to be automatically fed into the bread container; and
a control unit for executing a bread-making procedure for making bread, wherein
the bread-making procedure executed by the control unit is provided with a plurality of types of bread-making procedures, including a first bread-making procedure and a second bread-making procedure; and
the control unit varies the method of control related to the timing with which the bread ingredients are fed using the automatic feeding mechanism between in the first bread-making procedure and in the second bread-making procedure.

2. The automatic bread maker of claim 1, wherein the first bread-making procedure is a bread-making procedure used in the case that cereal grains are used as the starting ingredients, and the second bread-making procedure is a bread-making procedure that is used in the case that cereal flour is used as the starting ingredient.

3. The automatic bread maker of claim 2, wherein the first bread-making procedure includes a grinding step for grinding the cereal grains inside the bread container accommodated in the body.

4. The automatic bread maker of claim 1, wherein
both the first bread-making procedure and the second bread-making procedure include a kneading step for kneading the bread ingredients inside the bread container into bread dough;
the bread ingredients are fed using the automatic feeding mechanism midway through the kneading step in the case of the first bread-making procedure as well as the second bread-making procedure; and
the control unit controls the automatic feeding mechanism so that the time required from the start of the kneading step until the bread ingredients are automatically fed is shorter in the first bread-making procedure than in the second bread-making procedure.

5. The automatic bread maker of claim 1, wherein
the automatic feeding mechanism comprises a bread-ingredients-storage container and a lock release part, the bread-ingredients-storage container being adapted for storing a portion of the bread ingredients, and being provided with a lock mechanism, and the lock release part being adapted for releasing a locked state of the lock mechanism; and
the bread-ingredients-storage container has a container body having an aperture part; a lid body capable of opening and closing the aperture part, the lid body being swingably provided with respect to the container body; and a seal member for sealing the space between the container body and the lid body in a state in which the aperture part has been closed off by the lid body.

6. The automatic bread maker of claim 1, wherein dry yeast is included in the bread ingredients which are automatically fed by the automatic feeding mechanism in the case that the first bread-making procedure is executed.

7. The automatic bread maker of claim 6, wherein at least one among gluten, wheat flour, and a thickener is additionally included in the bread ingredients which are automatically fed by the automatic feeding mechanism in the case that the first bread-making procedure is executed.

8. The automatic bread maker of claim 1, wherein the bread ingredients which are automatically fed by the automatic feeding mechanism in the case that the second bread-making procedure is executed are additional ingredients for making bread with additional ingredients.

9. The automatic bread maker of claim 1, wherein different bread containers are used for the case in which the first bread-making procedure is executed and the case in which the second bread-making procedure is executed.
